(19) United States
(12) Patent Application Publication
(10) Pub. No.: US 2009/0051530 A1
(43) Pub. Date: Feb. 26, 2009

(54) ARTICLE TAGGING

(75) Inventors: Gary Leslie Brooks, Derbyshire (GB); Benjamin John Thompson, Nottingham (GB)

Correspondence Address: BANNER & WITCOFF, LTD., TEN SOUTH WACKER DRIVE, SUITE 3000, CHICAGO, IL, 60606, US

(73) Assignee: Filtrona United Kingdom Limited, Nottingham (GB)

(21) Appl. No.: 11/569,853

(22) PCT Filed: May 31, 2005
(86) PCT No.: PCT/GB2005/002148

§ 371 Date: Oct. 14, 2008

(30) Foreign Application Priority Data
Jun. 1, 2004 (GB) 0412193.5

(51) Int. Cl. C23F 1/00; B32B 37/00; B32B 38/10; G06K 19/06; G08B 13/14; B32B 38/00; B32B 38/14

(52) U.S. Cl. 340/568.1; 156/310; 156/277; 216/20; 156/264; 156/64; 156/353; 235/492

(57) ABSTRACT

A tagging material for the production of electronic identification tags. Shown generally at (10) is a continuous tape of thermoplastic plastics material. The tape (10) comprises a film (12) having on an upper surface a coating (14) of release agent, and on a lower surface a coating (16) of adhesive. Below the adhesive coating 16 is a further film (18) having on its upper surface an antenna (20) and, electrically connected thereto an integrated circuit (22). On a lower surface of film (18) is a coating of pressure sensitive adhesive (24). The integrated circuit (22) is completely encapsulated in a flexible protective layer (26) of non-conductive waterproof material, which is preferably UV-curable, such as polyurethane.

The present invention relates to article tagging and is concerned more particularly with the tagging of articles using Radio-Frequency Identification Devices (RFIDs).

It is known for retail stores to provide articles for sale with tags which are formed from electromagnetic sensor material which can be detected by detection equipment. Such tags are typically removed, or in some way deactivated, by a cashier at the point of sale. The purpose of this kind of tagging is to alert the retail store to the attempted theft of an article by detecting a tag which has not been removed or deactivated.

There are several different types of tag which can perform this function, but typically such tags comprise a simple ribbon or strip of magnetisable electromagnetic sensor material.

Another type of tag has been developed which includes an integrated circuit (IC) and an antenna. This type of tag is arranged to be irradiated by a suitable electromagnetic carrier wave, a fraction of the energy of which is used to provide power to the integrated circuit, which then produces a modulating signal which modulates the carrier wave and re-transmits it from the antenna. The modulating signal, once detected and filtered from the carrier wave can provide basic information concerning e.g. the nature, price, etc. of the article to which the tag is applied.

Tags of this kind, referred to as Radio-Frequency Identification Devices (RFIDs) have found application in retail stores, for the detection of articles passing through an unmanned point-of-sale, and e.g. for monitoring the progress of a parcel which passes through a number of postal or distribution centres.

RFIDs have hitherto been manufactured on sheets (with several RFIDs produced in an array). They typically comprise a portion of base film coated in adhesive, with an antenna and an integrated circuit formed thereon. Typically, the antenna is formed on the base film by a printing process and the integrated circuit is mounted thereon using a pick-and-place operation. It is essential that there is a good electrical connection between the antenna and the integrated circuit. The finished tags are then made into labels and applied manually to the desired article. This is necessarily a relatively slow process and is unsuited to high-speed techniques used in the modern packaging industry.

The tagging material may be according to any statement herein.

Preferred features of the present invention may be found in the appended sub-claims.

Preferred embodiments of the present invention will now be described by way of example only, with reference to the accompanying drawings, in which:

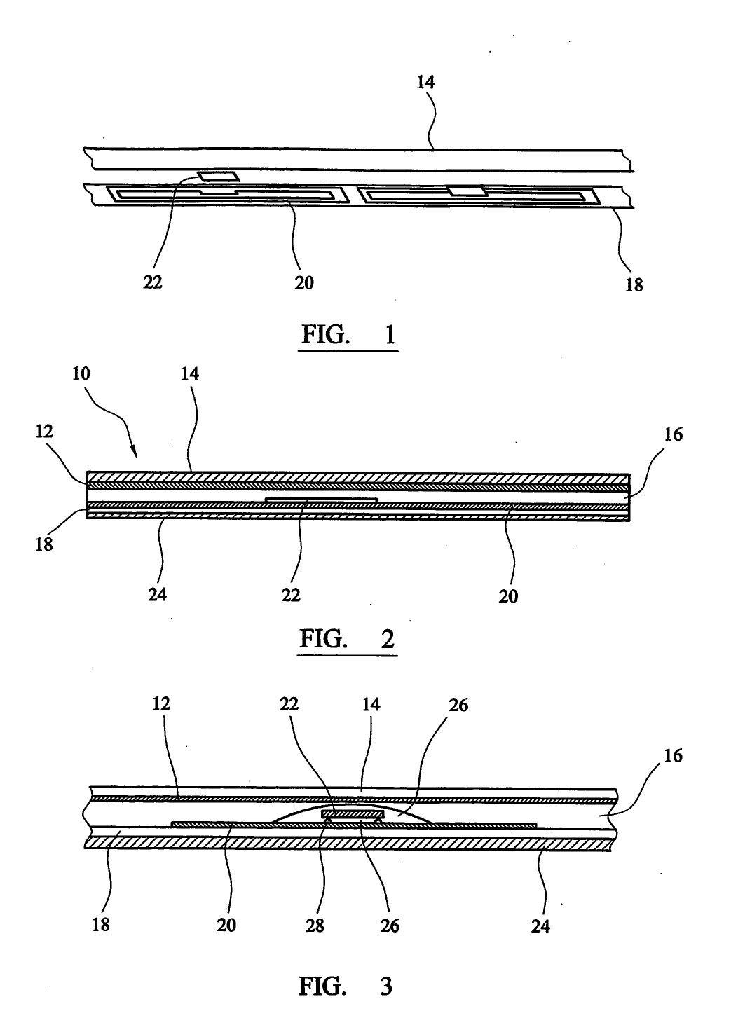

FIG. 1 shows, in partly exploded view, a portion of tagging material according to one embodiment of the present invention,

FIG. 2 is a longitudinal cross-section through the tagging material of FIG. 1 in assembled form,

FIG. 3 is a more detailed longitudinal cross-section through the tagging material of FIG. 1 in assembled form,

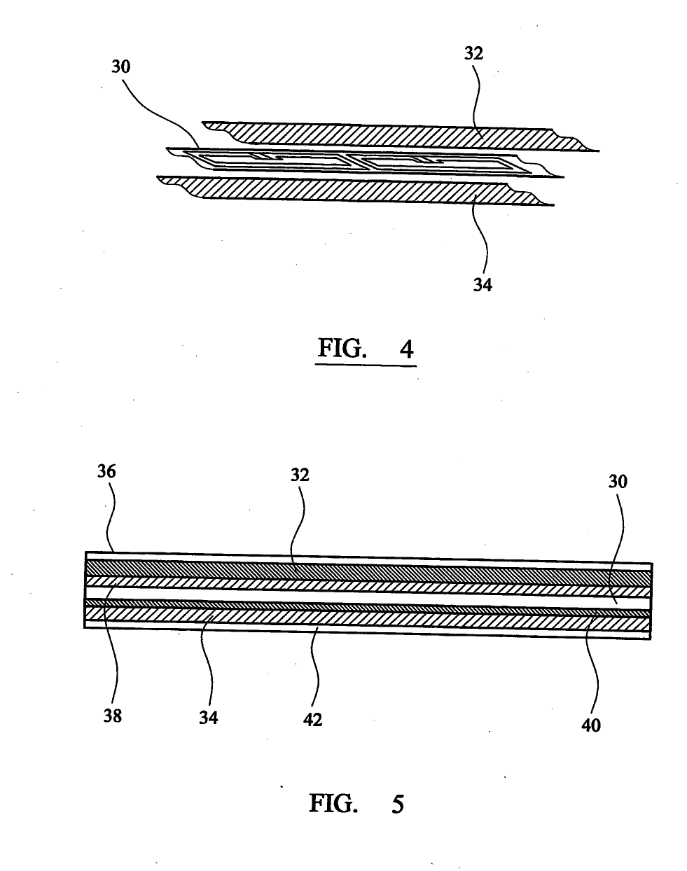

FIG. 4 shows in exploded view a portion of tagging material according to another embodiment of the present invention,

FIG. 5 is a longitudinal cross-section through the tagging material of FIG. 4,

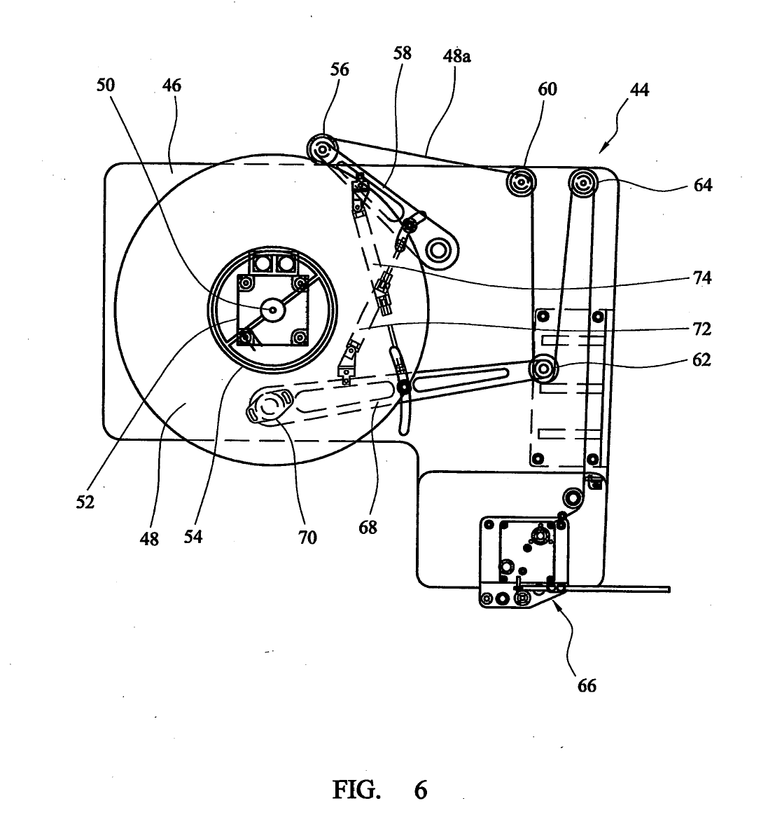

FIG. 6 is a schematic view of an applicator device for applying the tagging material of FIGS. 1 to 5 to articles, and

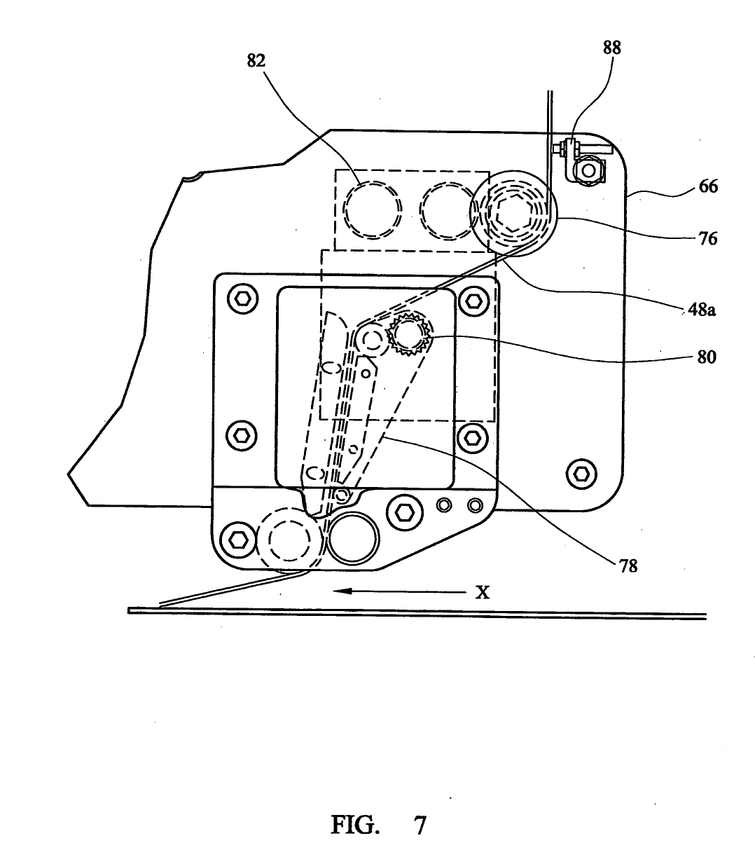

FIG. 7 is a close-up view of part of the applicator device of FIG. 6.

Referring to FIGS. 1 to 3, these show generally at 10 a continuous tape of thermoplastic plastics material. The tape 10 comprises a film 12 having on an upper surface a coating 14 of release agent, and on a lower surface a coating 16 of adhesive. Below the adhesive coating 16 is a further film 18 having on its upper surface an antenna 20 and, electrically connected thereto an integrated circuit 22. On a lower surface of film 18 is a coating of pressure sensitive adhesive 24. FIG. 4 shows in more detail the integrated circuit 22 which is completely encapsulated in a flexible protective layer 26 of non-conductive waterproof material, which is preferably UV-curable, such as polyurethane.

The integrated circuit 22 is electrically connected to the antenna 20 via conductive mounts 28 of epoxy resin.

In this embodiment, the integrated circuits (ICs) 22 are supplied as pre-fabricated, so-called “flip-chips” in small label format. The ICs are then mounted onto the antennae 20, which have been etched or printed onto the base film 18, before the tape in its final form is created.

There now follows a detailed example of a method of preparing a tape shown in FIGS. 1 to 3.

A web of monoaxially oriented polypropylene film having a chosen thickness of between approx. 12 μm (for light duty) and approx. 125 μm (for heavier duty) was formed in the conventional manner. Depending upon the application, films of different thicknesses, for example of 12 μm, 23 μm, 26 μm, 40 μm, 60 μm, 80 μm or 125 μm may be used. One surface of the web was then coated with a a commercially available silicone release system comprising of a polysiloxane polymer, a crosslinking agent and a platinum catalyst. It was applied to give a dry coating weight of 0.25 g/m², so forming the release layer.

The other surface of the web was then coated with a water-based acrylic emulsion, transparent pressure sensitive adhesive composition to form the adhesive layer. The adhesive was applied by a reverse gravure coating technique and was dried thoroughly through a number of air circulating ovens to give a final coating weight of between 5 and 40 g/m².

The thus coated web was then slit longitudinally into strips and each strip was then slit longitudinally so as to provide a plurality of pressure sensitive tapes of width 15 mm. Other widths could be used depending upon the application. For example, the strips could be slit to provide tapes of greater or lesser width, such as in the range 6-30 mm, for example 6 mm, 10 mm, 15 mm, 20 mm or 30 mm.

Taking one of the tapes, the RFID is formed thereon, as follows.

An antenna 20 is firstly formed on an upper surface of the tape. The antenna can either be formed by printing a suitably electrically conductive ink, or else by picking and placing a copper wire, by stamping out a conductive foil or by a copper plating method. If a conductive foil is used, suitable adhesive is chosen to secure the antenna to the substrate. Next, the conductive IC mounts 28 are formed at contact portions of the antenna 20, by depositing thereon pads of electrically conductive epoxy resin. Whilst the mounts 28 are still soft, the IC 22 is deposited, using a pick and place technique, such that the pre-formed contact “bumps” of the IC register with, and penetrate, the mounts 28. The IC 22 is then pressed further into its mounts 28, towards the tape, such that it sits at a critical predetermined height above the antenna mounting portions. The necessity to mount the IC at a carefully predetermined height arises from the fact that this height has a very significant effect upon the RF characteristics of the finished device.

Finally, the flexible protective layer 26 is applied to the upper side of the IC. It is deposited in three doses which flow together to cover completely the IC 22. Once in place, the layer 26 is hardened, typically by UV radiation to provide protection against the ingress of moisture and against shock. As a curable, water repellent non-conductive material, polyurethane is suitable for the layer 26.

Turning to FIGS. 4 and 5, these show an alternative embodiment of tagging material in which the material has been formed using proprietary preformed individual electronic devices—known as “inlays”, each of which comprises an integrated circuit and an antenna electrically connected thereto.

FIGS. 4 and 5 show a portion of tagging material comprising a length of inlay material 30 which is sandwiched between two films 32 and 34. The inlay material comprises a filmic substrate of thermoplastic plastics material such as PET which has, at regular intervals along its length, antennae which may be of copper or aluminium or conductive ink. Electrically connected to the antennae are individual RFID integrated circuits. The inlay material is supplied in rolls typically with 5000 individual devices per roll. The inlay material 30 is sandwiched between upper and lower strips 32, 34 of thermoplastic plastics film, such as monoaxially oriented polypropylene, the upper film 32 being coated on its upper surface with a layer 36 of release agent and being coated on its lower surface with a layer 38 of adhesive, and the lower layer 34 being coated on its upper surface with a layer 40 of adhesive and being coated on its lower surface with a layer 42 of pressure sensitive adhesive.

FIG. 6 shows a dispensing apparatus 44 for dispensing electronic identification tags for application to articles (not shown). The apparatus comprises a base plate 46 on which is mounted a reel 48 of tagging material 48a such as is described above in relation to FIGS. 1 to 3 or FIGS. 4 and 5. The reel 48 is driven rotatably about axle 50 by a servo-controlled unwind-motor 52, via an inflatable chuck 54.

The tagging material 48a is in the form of a tape, self-wound on the reel, i.e. successive turns of the material 48a traverse the width of the reel and adhere with low tack to their predecessors. The peeling off of the tape is effected by a peel-off rubber roller 56 mounted at a non-pivoting end of a pivotally mounted peel-off arm 58. After leaving the peel-off roller 56 the tape passes around a first fixed guide roller 60, a dancer plasma roller 62 and then a second fixed guide roller 64 before heading towards an applicator head 66 which is described below in detail with reference to FIG. 7. The dancer plasma roller 62 is located at the non-pivoting end of a pivotally mounted dancer arm 68. The pivoting end of dancer arm 68 is connected to a rotary potentiometer 70.

The peel-off arm 58 and dancer arm 68 are connected together by peel off pneumatic actuator 72 and dancer pneumatic actuator 74 and the whole is controlled by an electronic controller (not shown) with positional feedback from the potentiometer 70, such that the reel is driven to dispense the tagging material at an appropriate rate to match the demand for tagging material from the applicator head which itself is a function of the rate of supply of articles (not shown) to which tags are to be applied. The controller, peel-off arm and dancer arm act so as to create an accumulator within the dispenser 44, in order to supply the tagging material at high speed without applying too great a tensile stress to the tape.

FIG. 7 shows the applicator head 66 in more detail. The applicator head 66 comprises a roller 76 around which the tape 48a passes in use. The tape is fed by means of a tape feed belt 78 and tape feed pulley 80 which are driven by a tape feed servomotor 82 past a rotary cutter 84 before being pressed onto articles (not shown) travelling in direction of arrow X by application roller 86. A registration sensor 88 optically senses the presence on the tape 48a of a printed registration dot from which the apparatus can determine the exact position of an electronic device on the tape. The rotary cutter is 84 is controlled accordingly, so as to avoid cutting the tape 48a at the location of an electronic device and thereby wasting the device.

The dispenser 44 and applicator head 66 are preferably located within a cassette, in which the entire tape path between the dispensing reel and application roller 86 is optimised, to minimise the degree to which the tape is twisted in its delivery, and thus to minimise potential damage to the tape.

The present invention thus provides a tagging material, a method of manufacturing the same, and apparatus for applying tags to articles, in which the high-speed application of tags advantageously supplied in the form of a long, self-wound tape, is made possible.

1. A tagging material for production of an electronic identification tag for securing to an article, the tagging material being in the form of a self-windable continuous adhesive tape having a first surface coated with a pressure sensitive adhesive composition, the tape including a substantially continuous substrate of synthetic plastics material and a plurality of discrete electronic identification devices at spaced locations thereon, each electronic identification device comprising an integrated circuit device associated with, and electrically connected to, an antenna.

2. A tagging material according to claim 1, wherein the tape has a second, opposed surface coated with release agent.

3. A tagging material according to claim 1, wherein the devices are located on a filmic substrate and the filmic substrate is sandwiched between first and second continuous film layers to which it is adhered by adhesive.

4. A tagging material according to claim 3, wherein each of the first and second film layers has an inwardly facing surface which faces the device and an outwardly facing surface which faces away from the device.

5. A tagging material according to claim 3 wherein each of the first and second films has an inwardly facing surface which is coated with adhesive.

6. A tagging material according to any of claim 3 wherein one of the first and second films has an outwardly facing surface which is coated with a release agent and the other of the first and second films has an outwardly facing surface which is coated with pressure sensitive adhesive.

7. A method of manufacture of tagging material for production of an electronic identification tag for securing to an article, the tagging material being in the form of a self-windable continuous tape, the method comprising the steps of taking a strip of filmic substrate having pre-formed thereon a plurality of discrete complete electronic identification devices, each comprising an integrated circuit and an antenna, at spaced locations and bonding to one surface of the substrate a first base film having an inwardly facing surface coated with adhesive for bonding to the substrate and an outwardly facing surface coated with adhesive, and bonding to the other, opposed surface of the substrate a second base film having an inwardly facing surface coated with adhesive for bonding to the substrate.

8. A method according to claim 7 wherein the method comprises bonding to the other surface of the substrate a second base film which has an outwardly facing surface coated with release agent.

9. A method according to claim 7 wherein the method includes taking strip of filmic substrate which has devices comprising integrated circuits, each electrically connected to an antenna, which may be of e.g. copper, aluminium or conductive ink.

10. A method according to any of claim 7 wherein the method includes taking a strip of filmic substrate comprising a thermoplastic film such as PET.

11. A method of manufacture of tagging material for production of an electronic identification tag for securing to an article, the tagging material being in the form of a self-windable continuous tape, the method comprising the steps of taking a strip of filmic substrate, forming antennae on a first surface thereof, placing on the substrate a plurality of discrete radio-frequency integrated circuits at spaced locations and electrically connecting them to respective antennae, taking a film having upper and lower surfaces coated with adhesive and bonding the film to said substrate.

12. A method according to claim 11 wherein the method includes coating a surface of the substrate with release agent.

13. A method according to claim 11 wherein the antennae are formed on the substrate by printing or etching.

14. A method according to any of claim 11 wherein the antennae are formed as discrete, individual antennae.

15. A method according to any of claim 11 wherein the antennae are formed as a continuous antenna, for subsequent division.

16. A method according to any of claim 11 wherein the radio-frequency integrated circuits are preformed as discrete self-adhesive labels for placing onto the substrate.

17. A method of applying an electronic identification tag to an article, the method comprising moving tagging material comprising a self-windable continuous adhesive tape having a first surface coated with a pressure sensitive adhesive composition, the tape including a substantially continuous substrate of synthetic plastics material and a plurality of discrete electronic identification devices at spaced locations thereon, each electronic identification device comprising an antenna and electrically connected thereto an integrated circuit device, the method further comprising causing an article to move along an article path, moving the tagging material on a tagging material path which converges with the article path, severing a portion of the tagging material including at least one of said discrete electronic identification devices to form a tag, and causing the tag to adhere to the article by means of the pressure sensitive adhesive.

18. A method according to claim 17 including monitoring the position of the discrete electronic identification devices in the tape and operating cutting means to severe the tagging material in accordance with the positions of said devices on the tape.

19. Apparatus for applying an electronic identification tag to an article, the apparatus comprising dispensing means for dispensing tagging material comprising a self-windable continuous adhesive tape having a first surface coated with a pressure sensitive adhesive composition, the tape including a substantially continuous substrate of synthetic plastics material and a plurality of discrete electronic identification devices at spaced locations thereon, each electronic identification device comprising an antenna member and electrically connected thereto an integrated circuit device, to an application head, the application head comprising registration sensing means for detecting positions of devices on the tape, and cutting means for cutting the tape to produce discrete tags.

20. Apparatus according to claim 19, wherein the dispensing means and the cutting means are driven independently.

21. Apparatus according to claim 19 wherein the dispensing means is driven by a first servo-controlled motor.

22. Apparatus according to any of claim 19 wherein the cutting means is driven by a second servo-controlled motor in accordance with registration sensing means.
